(19) United States
(12) Patent Application Publication
(10) Pub. No.: US 2026/0065210 A1
(43) Pub. Date: Mar. 5, 2026

(54) PRODUCT WEBPAGE ATTRIBUTE VALUE QUALITY DETERMINATION AND PREDICTION

(71) Applicant: Rakuten Group, Inc., Tokyo (JP)

(72) Inventors: Priyavrath DAKUA, Bangalore (IN); Eshant SAHU, Bangalore (IN); Hari Charan RAO, Bangalore (IN)

(21) Appl. No.: 18/821,287

(22) Filed: Aug. 30, 2024

(51) Int. Cl. G06Q 10/0639

(52) U.S. Cl. CPC G06Q 10/06395

(57) ABSTRACT

Product webpage attribute value quality determination and prediction is performed by preparing a plurality of product webpage datasets, each product webpage dataset including a plurality of attribute values extracted from a product webpage and a plurality of attribute types and each attribute value is associated with a corresponding attribute type, applying a quality determining model to the plurality of product webpage datasets to produce a quality value associated with each attribute value among the plurality of attribute values included in a target product webpage dataset, and applying an attribute value predicting model to the plurality of product webpage datasets to produce a predicted attribute value for a target attribute value associated with a quality value lower than a threshold quality value. The target attribute value is among the plurality of attribute values included in the target product webpage dataset.

### FIELD

The present disclosure relates to product webpage attribute value quality determination and prediction.

### BACKGROUND

In marketplace websites, many individual product webpages are managed. Product webpages are constantly being created in response to new products entering the market. As products are modified, corresponding webpages are updated. Many marketplace websites operate in a similar manner, with product webpages having similar product attributes.

### SUMMARY

Product webpage attribute value quality determination and prediction is performed by preparing a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types, applying a quality determining model to the plurality of product webpage datasets to produce a quality value associated with each attribute value among the plurality of attribute values included in a target product webpage dataset among the plurality of product webpage datasets, and applying an attribute value predicting model to the plurality of product webpage datasets to produce a predicted attribute value for a target attribute value associated with a quality value lower than a threshold quality value, wherein the target attribute value is among the plurality of attribute values included in the target product webpage dataset.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a system for product webpage attribute value quality determination and prediction, according to at least some embodiments of the subject disclosure.

FIG. 2 is an apparatus for product webpage dataset preparation, according to at least some embodiments of the subject disclosure.

FIG. 3 is an apparatus for product webpage attribute enrichment, according to at least some embodiments of the subject disclosure.

FIG. 4 is an operational flow for product webpage attribute value quality determination and prediction, according to at least some embodiments of the subject disclosure.

FIG. 5 is an operational flow for enriching target product webpage dataset, according to at least some embodiments of the subject disclosure.

FIG. 6 illustrates an embodiment of a device for product webpage attribute value quality determination and prediction, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

As product webpages are created and updated en masse, attributes that describe the product may be missing or inaccurate. Such absences or inaccuracies are generally not consistent across marketplace websites. Some absences or inaccuracies conflict with other attributes of a given product webpage. For example, a product webpage may feature an image that is clearly of one color, yet also includes a text description of another color. Although current systems known to the inventors are capable of scraping a domain, detection and suggestion of enrichment that needs to be done is performed manually.

In at least some embodiments of the present disclosure, a system scrapes all the product webpages displayed in a website domain by deep crawling through multiple domains, such as domains of marketplace websites. In at least some embodiments, the system detects attributes from an HTML webpage. In at least some embodiments, the system performs product matching to group webpages by product. In at least some embodiments, the system checks the data quality and suggests values for attributes of low quality or missing attributes, based on attribute values of other webpages of the same product.

In at least some embodiments, a loop of scraping and cleansing improves the overall quality of data that is displayed in the marketplace website.

In at least some embodiments, the system includes a quality determining model and an attribute value predicting model. In at least some embodiments, the system generates reports that suggest attribute values for webpages. In at least some embodiments, the system trains the models using training samples prepared by annotaters who review the reports.

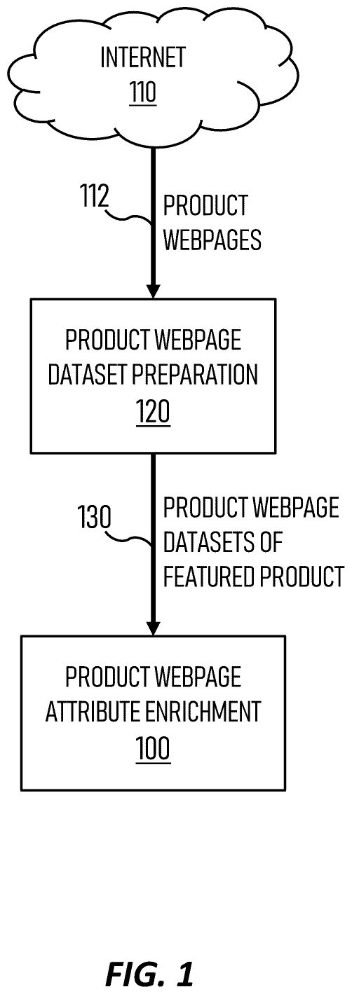

FIG. 1 is a system for product webpage attribute value quality determination and prediction, according to at least some embodiments of the subject disclosure. The system includes internet 110, product webpage dataset preparation 120, and product webpage attribute enrichment 100.

Internet 110 is in communication with product webpage dataset preparation 120. In at least some embodiments, internet 110 is configured to serve as the source of product webpages 112 from various domains. In at least some embodiments, internet 110 is configured to provide these webpages to product webpage dataset preparation 120 for further processing. In at least some embodiments, internet 110 is configured to enable general internet browsing and data retrieval. In at least some embodiments, internet 110 includes various servers and databases for data retrieval. In at least some embodiments, internet 110 is accessed through internet service providers, using protocols such as Wi-Fi, Ethernet, etc. In at least some embodiments, internet 110 is commonly used for web browsing, data streaming, online gaming, etc.

Product webpages 112 are retrieved from internet 110 and provided to product webpage dataset preparation 120 for attribute extraction. In at least some embodiments, product webpages 112 contain information about various products. In at least some embodiments, product webpages 112 are retrieved from internet 110. In at least some embodiments, product webpages 112 are provided to product webpage dataset preparation 120. In at least some embodiments, product webpages 112 include product information in a format to be displayed to users. In at least some embodiments, product webpages 112 are represented by HTML, CSS, JavaScript, etc., files. In at least some embodiments, product webpages 112 are of the type commonly used in e-commerce, product reviews, product specifications, etc.

Product webpage dataset preparation 120 is in communication with internet 110 and product webpage attribute enrichment 100. In at least some embodiments, product webpage dataset preparation 120 is configured to extract attribute values and types from product webpages 112. In at least some embodiments, product webpage dataset preparation 120 is configured to prepare datasets. In at least some embodiments, product webpage dataset preparation 120 is configured to prepare a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types. In at least some embodiments, product webpage dataset preparation 120 receives product webpages 112 from internet 110. In at least some embodiments, product webpage dataset preparation 120 provides datasets to product webpage datasets of featured product 130. In at least some embodiments, product webpage dataset preparation 120 is represented by data extraction and preprocessing scripts.

Product webpage datasets of featured product 130 are retrieved from product webpage dataset preparation 120 and provided to product webpage attribute enrichment 100. In at least some embodiments, product webpage datasets of featured product 130 include the prepared datasets of a single featured product for product webpage attribute value quality determination and prediction. In at least some embodiments, a featured product is described by each attribute value among the plurality of attribute values included in each product webpage dataset among the plurality of product webpage datasets in product webpage datasets of featured product 130. In at least some embodiments, product webpage datasets of featured product 130 includes grouped product data for each featured product. In at least some embodiments, product webpage datasets of featured product 130 are in a format suitable for input to a quality determining model and an attribute value predicting model for processing. In at least some embodiments, product webpage datasets of featured product 130 include attribute values corresponding to attribute types extracted from product webpages. In at least some embodiments, product webpage datasets of featured product 130 are provided to product webpage attribute enrichment 100. In at least some embodiments, product webpage datasets of featured product 130 are represented by databases, dataframes, etc. In at least some embodiments, product webpage datasets of featured product 130 include files in a JSON, XML, YAML, etc. format.

Product webpage attribute enrichment 100 receives product webpage datasets of featured product 130 from product webpage dataset preparation 120. In at least some embodiments, product webpage attribute enrichment 100 applies quality determining and attribute value predicting models to product webpage datasets of featured product 130. In at least some embodiments, product webpage attribute enrichment 100 is configured to enrich the product webpage attributes. In at least some embodiments, product webpage attribute enrichment 100 receives these datasets from product webpage datasets of featured product 130. In at least some embodiments, product webpage attribute enrichment 100 modifies the product webpages based on the model results. In at least some embodiments, product webpage attribute enrichment 100 is represented by machine learning models, data analysis scripts, etc.

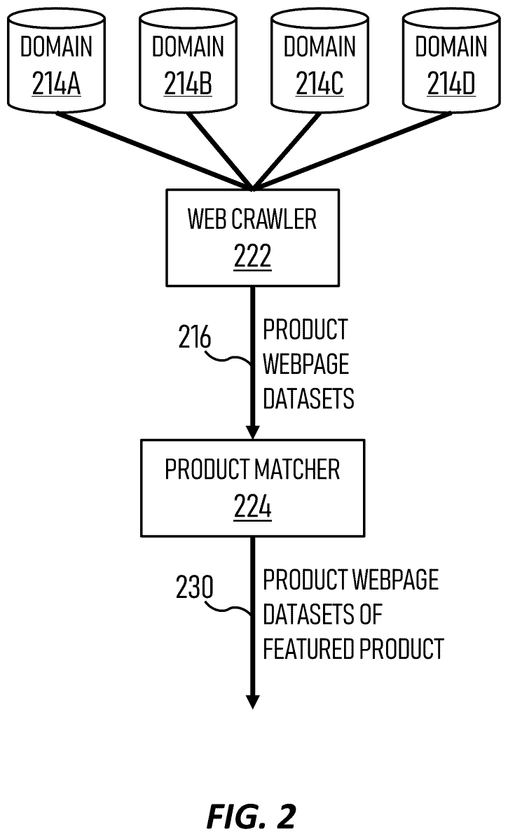

FIG. 2 is an apparatus for product webpage dataset preparation, according to at least some embodiments of the subject disclosure. The apparatus includes domain 214, web crawler 222, product webpage datasets 216, product matcher 224, and product webpage datasets of featured product 230. In at least some embodiments, the apparatus is an example of product webpage dataset preparation 120 of FIG. 1. Product webpage datasets of featured product 230 are substantially similar in structure and function to product webpage datasets of featured product 130 of FIG. 1, except as otherwise indicated below.

Domains 214A, 214B, 214C, and 214D are specific websites or sets of websites from which data is extracted. In at least some embodiments, domains 214A, 214B, 214C, and 214D are configured to be the specific website or set of websites from which the system is designed to scrape data. In at least some embodiments, domains 214A, 214B, 214C, and 214D provides the initial data source for web crawler 222. In at least some embodiments, domains 214A, 214B, 214C, and 214D can refer to any website or online platform. In at least some embodiments, domains 214A, 214B, 214C, and 214D include website domains, such as “amazon.com” or “ebay.com”.

Web crawler 222 is in communication with domains 214A, 214B, 214C, and 214D. In at least some embodiments, web crawler 222 is configured to traverse domain 214 and extract the HTML code of each product webpage. In at least some embodiments, web crawler 222 gathers data from domains 214A, 214B, 214C, and 214D and extracts product webpage datasets 216. In at least some embodiments, web crawler 222 is of the type used in various applications, such as search engines and data mining. In at least some embodiments, web crawler 222 is of the type used to index web pages for search engines.

Product webpage datasets 216 are produced by web crawler 222 and provided to product matcher 224. In at least some embodiments, product webpage datasets 216 include product data extracted from product webpages by web crawler 222. In at least some embodiments, product webpage datasets 216 are provided to product matcher 224 to group similar products together. In at least some embodiments, product webpage datasets 216 include files in a JSON, XML, YAML, etc. format.

Product matcher 224 is in communication with web crawler 222. In at least some embodiments, product matcher 224 is configured to group similar products together based on the data in product webpage datasets 216 to create product webpage datasets of featured product 230. In at least some embodiments, product matcher 224 is a machine learning model or a rule-based matching algorithm. In at least some embodiments, product matcher 224 is a matching algorithm of the type used in recommendation systems, search engines, data deduplication, etc.

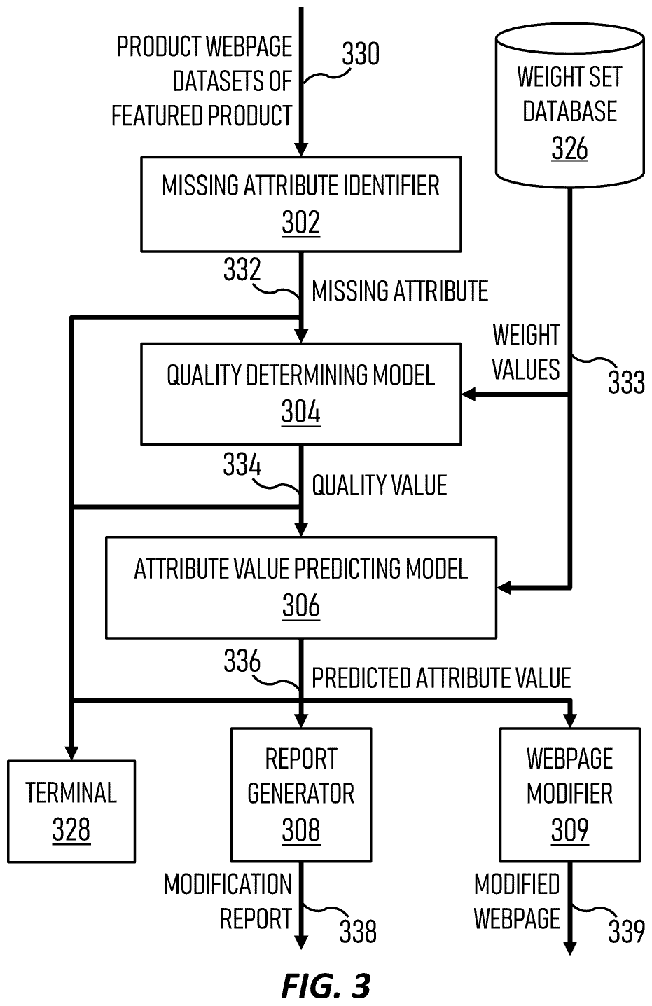

FIG. 3 is an apparatus for product webpage attribute enrichment, according to at least some embodiments of the subject disclosure. The system includes product webpage datasets of featured product 330, missing attribute identifier 302, missing attribute 332, weight set database 326, weight values 333, quality determining model 304, quality value 334, attribute value predicting model 306, predicted attribute value 336, terminal 328, report generator 308, modification report 338, webpage modifier 309, and modified webpage 339. Product webpage datasets of featured product 330 are substantially similar in structure and function to product webpage datasets of featured product 130 of FIG. 1 and product webpage datasets of featured product 230 of FIG. 2, except as otherwise indicated below.

Missing attribute identifier 302 is in communication with quality determining model 304 and terminal 328. In at least some embodiments, missing attribute identifier 302 is configured to process product webpage datasets of featured product 330 to identify missing attributes, such as missing attribute 332. In at least some embodiments, missing attribute identifier 302 is configured to compare attribute types of a target product webpage dataset of a featured product to other datasets among product webpage datasets of featured product 330. In at least some embodiments, missing attribute identifier 302 is configured to output the attribute type of any missing attributes, such as missing attribute 332, to quality determining model 304 and terminal 328. In at least some embodiments, missing attribute identifier 302 is configured to output the attribute type of any missing attributes, such as missing attribute 332, along with an attribute value. In at least some embodiments, missing attribute identifier 302 is configured to output the attribute value of any missing attributes based on attribute values of the attribute type from other datasets among product webpage datasets of featured product 330. In at least some embodiments, missing attribute identifier 302 is a function or method in a data processing script or program.

Weight set database 326 is in communication with quality determining model 304 and attribute value predicting model 306. In at least some embodiments, weight set database 326 stores sets of weight values, such as weight values 333, for different attribute types used in quality determining model 304 and attribute value predicting model 306. In at least some embodiments, each set of weight values includes a weight value for each attribute type other than a target attribute type. For example, if the target attribute type is “color”, then a weight value for an attribute type of “title” might be 0.9 while a weight value for an attribute type of “model number” might be 0.4, to indicate that the attribute type of “title” is more relevant to the color than the attribute type of “model number”. In at least some embodiments, each weight value in weight set database 326 is a hyper-parameter that is tunable by a user. In at least some embodiments, the one or more weight values are included in a weight set corresponding to a target attribute type among the plurality of attribute types. In at least some embodiments, weight set database 326 provides weight values to quality determining model 304 and attribute value predicting model 306. In at least some embodiments, weight set database 326 is represented as a database or a data file.

Quality determining model 304 is in communication with missing attribute identifier 302, attribute value predicting model 306, weight set database 326, and terminal 328. In at least some embodiments, quality determining model 304 is trained to determine the quality of attribute values in product webpage datasets of featured product 330. In at least some embodiments, quality determining model 304 is trained to determine the quality of attribute values in product webpage datasets of featured product 330. In at least some embodiments, quality determining model 304 is configured to use weight values, such as weight values 333 from weight set database 326, to determine quality. In at least some embodiments, quality determining model 304 is trained to determine quality in the form of a quality value, such as quality value 334. In at least some embodiments, quality determining model 304 is configured to compare the attribute value of each attribute type of a target product webpage dataset with attribute values of the same attribute type of other datasets in product webpage datasets of featured product 330 to determine a quality value. In at least some embodiments, a quality value, such as quality value 334, represents a similarity of the attribute value in the target product webpage dataset to attribute values of the same attribute type in other datasets in product webpage datasets of featured product 330. In at least some embodiments, quality determining model 304 is configured to consider a product image. In at least some embodiments, quality determining model 304 is configured to output quality values, such as quality value 334, to attribute value predicting model 306 and terminal 328. In at least some embodiments, quality determining model 304 is a machine learning model. In at least some embodiments, quality determining model 304 is a machine learning model trained to qualify attribute values of a single product type. In at least some embodiments, quality determining model 304 is trained for a product category of the featured product.

Attribute value predicting model 306 is in communication with quality determining model 304, weight set database 326, report generator 308, webpage modifier 309, and terminal 328. In at least some embodiments, attribute value predicting model 306 is trained to predict attribute values to replace low-quality attribute values in the target product webpage dataset. In at least some embodiments, attribute value predicting model 306 is trained to predict an attribute value in the target product webpage dataset based on attribute values of the same attribute type in other datasets in product webpage datasets of featured product 330. In at least some embodiments, attribute value predicting model 306 is configured to consider a product image. In at least some embodiments, attribute value predicting model 306 is used in any task requiring prediction. In at least some embodiments, attribute value predicting model 306 is configured to output predicted attribute values, such as predicted attribute value 336, to report generator 308, webpage modifier 309, and terminal 328. In at least some embodiments, attribute value predicting model 306 is a machine learning model. In at least some embodiments, attribute value predicting model 306 is a machine learning model trained to predict attribute values of a single product type. In at least some embodiments, attribute value predicting model 306 is trained for a product category of the featured product.

Terminal 328 is in communication with missing attribute identifier 302, quality determining model 304, and attribute value predicting model 306. In at least some embodiments, terminal 328 is configured to provide an interface for users to interact with the system. In at least some embodiments, terminal 328 is configured to display original attribute values about a target product webpage dataset as well as other information, such as missing attribute 332, quality value 334, and predicted attribute value 336. In at least some embodiments, terminal 328 is a personal computing device, such as a computer, laptop, smartphone, or any other computing device having a command-line interface, a graphical user interface, or a web interface.

Report generator 308 is in communication with attribute value predicting model 306. In at least some embodiments, report generator 308 is configured to generate reports detailing any missing attributes, low-quality attribute types, and corresponding predicted attribute values. In at least some embodiments, report generator 308 is configured to generate reports, such as modification report 338, including output of missing attribute identifier 302, quality determining model 304, and attribute value predicting model 306 with respect to a target product webpage dataset. In at least some embodiments, report generator 308 is a function or method in a data processing script or program.

Webpage modifier 309 is in communication with attribute value predicting model 306. In at least some embodiments, webpage modifier 309 is configured to modify product webpages based on any missing attributes, low-quality attribute types, and corresponding predicted attribute values. In at least some embodiments, webpage modifier 309 is configured to output modified webpages, such as modified webpage 339, based on output of missing attribute identifier 302, quality determining model 304, and attribute value predicting model 306 with respect to a target product webpage dataset. In at least some embodiments, webpage modifier 309 is a function or method in a web editing script or program.

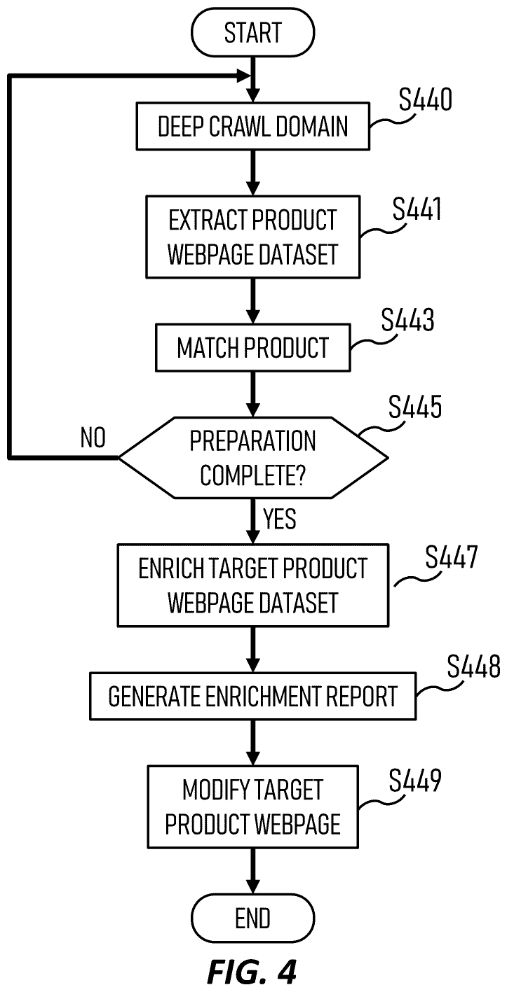

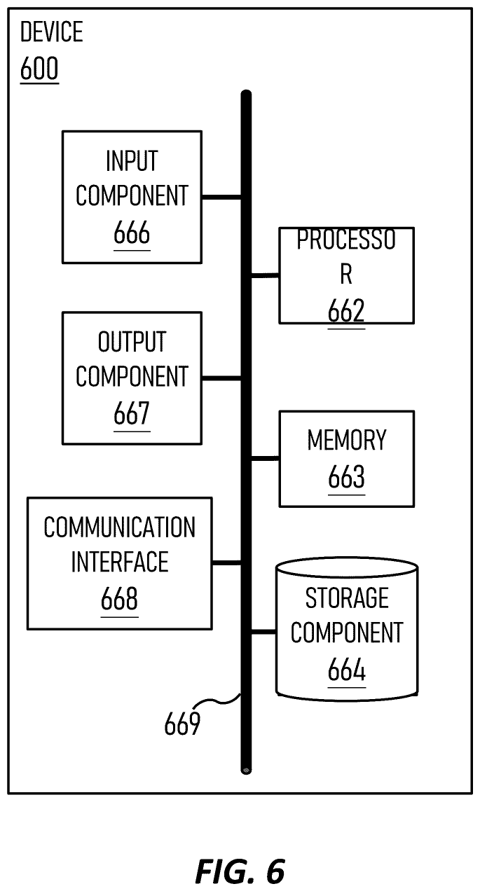

FIG. 4 is an operational flow for product webpage attribute value quality determination and prediction, according to at least some embodiments of the subject disclosure. In at least some embodiments, the operational flow provides a method of product webpage attribute value quality determination and prediction, according to at least some embodiments of the subject disclosure. In at least some embodiments, the method is performed by a processor of a device, such as processor 662 of device 660 of FIG. 6, described hereinafter.

At S440, the processor or a section thereof performs deep crawling of a domain. In at least some embodiments, the processor systematically browses a website domain to index its pages and extract data. In at least some embodiments, in response to navigating through the website domain's structure, including subdomains, the processor gathers comprehensive data. In at least some embodiments, the processor obtains access to the website domain and necessary permissions for crawling.

At S441, the processor or a section thereof extracts product webpage datasets. In at least some embodiments, the processor processes the data collected from the deep crawl to extract specific information related to product webpages. In at least some embodiments, the processor extracts, from each product webpage among the plurality of product webpages, the plurality of attribute values, as part of preparing a plurality of product webpage datasets. In at least some embodiments, this information includes attribute values and attribute types associated with each product. In at least some embodiments, the processor generates a structured dataset from the raw data for each product webpage. In at least some embodiments, the processor produces a structured dataset containing attribute values and attribute types for each product webpage. In at least some embodiments, the processor organizes the dataset in a way that facilitates the comparison and analysis of data related to the same product across different webpages. In at least some embodiments, the processor associates, with each attribute value among the plurality of attribute values extracted from each product webpage among the plurality of product webpages, the corresponding attribute type, as part of preparing a plurality of product webpage datasets.

At S443, the processor or a section thereof matches products. In at least some embodiments, the processor groups the extracted data by product. In at least some embodiments, the processor identifies and matches webpages that correspond to the same product. In at least some embodiments, the processor assembles the plurality of product webpage datasets, as part of preparing a plurality of product webpage datasets. In at least some embodiments, the processor requires the completion of the data extraction operation and a predefined set of rules or algorithms to identify and match products. In at least some embodiments, the processor results in a restructured dataset where data is grouped by product.

At S445, the processor or a section thereof checks if preparation is complete. In response to preparation not being complete, the operational flow returns to deep crawling at S440. In response to preparation being complete, the operational flow proceeds to enriching at S447. In at least some embodiments, the processor checks whether a preparation phase including deep crawling, data extraction, and product matching is complete. In at least some embodiments, preparation is complete when product webpage datasets have been extracted from all target domains. In at least some embodiments, the processor determines that the preparation phase is complete and satisfactory before proceeding to the enrichment phase.

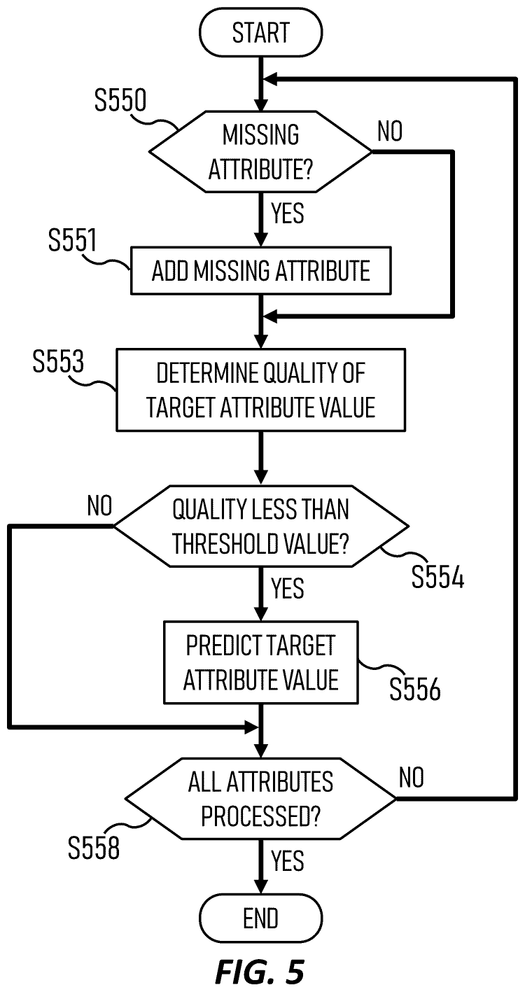

At S447, the processor or a section thereof enriches the target product webpage dataset. In at least some embodiments, the processor enhances the target product webpage dataset by applying a quality determining model and an attribute value predicting model. In at least some embodiments, the processor improves the quality of the dataset by identifying low-quality or missing attribute values and predicting their values. In at least some embodiments, wherein the target product webpage dataset includes a product image. In at least some embodiments, the processor results in an enriched dataset with improved attribute value quality. In at least some embodiments, the processor enriches the target product webpage dataset by performing the operational flow of FIG. 5, described hereinafter.

At S448, the processor or a section thereof generates an enrichment report. In at least some embodiments, the processor generates an enrichment report that includes any missing attribute values and predicted attribute values. In at least some embodiments, the processor generates a report for the target product webpage, the report including the target attribute value and the predicted attribute value. In at least some embodiments, the processor provides a detailed account of the enrichment process, highlighting the improvements made to the dataset. In at least some embodiments, the processor generates an enrichment report that includes side-by-side comparisons of product webpage datasets for confirmation. In at least some embodiments, the processor generates an enrichment report that includes suggested training data for a quality determining model and an attribute value predicting model.

At S449, the processor or a section thereof modifies the target product webpage. In at least some embodiments, the processor updates the target product webpage to add missing attribute values and replace low-quality attribute values with predicted attribute values. In at least some embodiments, the processor modifies the target product webpage to replace the target attribute value and the predicted attribute value.

In at least some embodiments, the processor does not modify the target product webpage until the generated enrichment report is approved by a user. In at least some embodiments, a terminal displays the generated enrichment report to a user. In at least some embodiments, a terminal transmits modifications selected by the user to a webpage modifier.

FIG. 5 is an operational flow for enriching target product webpage dataset, according to at least some embodiments of the subject disclosure. In at least some embodiments, the operational flow provides a method of enriching target product webpage dataset, according to at least some embodiments of the subject disclosure. In at least some embodiments, the method is performed by a processor of a device, such as processor 662 of device 660 of FIG. 6, described hereinafter.

At S550, the processor or a section thereof checks for missing attributes. In response to a missing attribute not being detected, the operational flow proceeds to quality determination at S553. In response to a missing attribute being detected, the operational flow proceeds to adding the missing attribute at S551. In at least some embodiments, the processor checks each attribute type in the product webpage datasets to identify if any attribute type is missing in the target product webpage dataset. In at least some embodiments, the processor detects an attribute type among the plurality of attribute types of at least one product webpage dataset that is not included in the plurality of attribute types of the target webpage dataset.

At S551, the processor or a section thereof adds the missing attribute. In at least some embodiments, the processor adds the missing attribute type to the target product webpage dataset. In at least some embodiments, the processor adds an attribute value to the missing attribute type. In at least some embodiments, the processor adds the detected attribute type and corresponding attribute value included in the at least one product webpage dataset to the target product webpage dataset. In at least some embodiments, the processor determines an attribute value for the missing attribute type based on attribute values for the missing attribute type in the product webpage datasets.

At S553, the processor or a section thereof determines the quality of the target attribute value. In at least some embodiments, the processor applies a quality determining model to the product webpage datasets to produce a quality value representing a quality of the target attribute value in the target product webpage dataset. In at least some embodiments, the processor applies a quality determining model to the plurality of product webpage datasets to produce a quality value associated with each attribute value among the plurality of attribute values included in a target product webpage dataset among the plurality of product webpage datasets. In at least some embodiments, the processor produces a quality value of between 0.0 and 1.0. In at least some embodiments, the processor applies a quality determining model using a weight set corresponding to the target attribute value. In at least some embodiments, applying the quality determining model includes applying one or more weight values to the plurality of attribute types. In at least some embodiments, the processor applies a quality determining model that has been trained for a featured product of the product webpage datasets.

At S554, the processor or a section thereof compares the quality value with a threshold value. In response to the quality value not being less than the threshold value, the operational flow proceeds to attribute process determination at S558. In response to the quality value being less than the threshold value, the operational flow proceeds to predicting the target attribute value at S556. In at least some embodiments, the threshold quality value is a hyper-parameter tunable by a user of the system.

At S556, the processor or a section thereof predicts the target attribute value. In at least some embodiments, the processor applies an attribute value predicting model to the product webpage datasets to produce a predicted attribute value for the target attribute value of the target product webpage dataset. In at least some embodiments, the processor applies an attribute value predicting model to the plurality of product webpage datasets to produce a predicted attribute value for a target attribute value associated with a quality value lower than a threshold quality value, wherein the target attribute value is among the plurality of attribute values included in the target product webpage dataset. In at least some embodiments, the processor applies an attribute value predicting model using a weight set corresponding to the target attribute value. In at least some embodiments, the processor applies an attribute value predicting model that has been trained for a featured product of the product webpage datasets.

At S558, the processor or a section thereof determines whether all attributes have been processed. In response to less than all attributes being processed, the operational flow returns to quality determination at S553. In response to all attributes being processed, the operational flow ends. In at least some embodiments, the processor determines whether all attribute types identified in the product webpage datasets have been processed.

FIG. 6 illustrates an embodiment of a device 660 for product webpage attribute value quality determination and prediction, according to at least some embodiments of the subject disclosure. As shown in FIG. 6, device 660 includes processor 662, memory 663, storage component 664, input component 666, output component 667, communication interface 668, and bus 669.

The processor 662, as used herein, means any type of computational circuit that may comprise hardware elements and software elements. The processor 662 may be embodied as a multi-core processor, a single core processor, or a combination of one or more multi-core processors and/or one or more single core processors, a distributed processing system, or the like. The processor 662 may be a Central Processing Unit (CPU), a graphics processing unit (GPU), an accelerated processing unit (APU), an application-specific integrated circuit (ASIC), or another type of processing component.

Memory 663 includes a non-transitory computer readable medium. Memory 663 includes a random-access memory (RAM), a read only memory (ROM), and/or another type of dynamic or static storage device (e.g., a flash memory, a magnetic memory, and/or an optical memory) that stores information and/or instructions for use by processor 662. The memory 663 comprises machine-readable instructions which are executable by the processor 662. These machine-readable instructions when executed by the processor 662 cause the processor 662 to perform one or more method steps of an embodiment described above.

Storage component 664 stores information and/or software related to the operation and use of the device 660. For example, storage component 664 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 666 is configured to receive information, such as user input. For example, the input component 666 may include, but not be limited to, a touch screen display, a keyboard, a keypad, a mouse, a button, a switch, and/or a microphone. Additionally, or alternatively, the input component 666 may include a sensor for sensing information (e.g., a global positioning system (GPS), an accelerometer, a gyroscope, and/or an actuator).

Output component 667 is configured to provide output information from the device 660. For example, the output component 667 may be, but not limited to, a display, a speaker, an instruction device to an external device, and/or one or more light-emitting diodes (LEDs).

communication interface 668 is an interface that provides a communication connection to other devices, such as external devices and internal devices. The connection by the communication interface 668 can be a wired connection, a wireless connection, or a combination of wired and wireless connections, and can be a direct connection or an indirect connection via a communication network that exists between the device 660 and other devices. In other words, the standard of the communication interface 668 is not limited.

The bus 669 acts as an interconnect between the processor 662, the memory 663, the storage component 664, the input component 666, the output component 667, and the communication interface 668 of the device 660. The bus 669 may include a wired interconnection or a wireless interconnection.

The number and arrangement of components shown in FIG. 6 are provided as an example. In practice, device 660 may include additional components, fewer components, different components, or differently arranged components than those shown in FIG. 6. Additionally, or alternatively, a set of components (e.g., one or more components) of device 660 may perform one or more functions described as being performed by another set of components of device 660. Further, one or more method steps described in any of the embodiments may be performed utilizing a plurality of device 660 in communication with one another.

In at least some embodiments, product webpage attribute value quality determination and prediction is performed by preparing a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types, applying a quality determining model to the plurality of product webpage datasets to produce a quality value associated with each attribute value among the plurality of attribute values included in a target product webpage dataset among the plurality of product webpage datasets, and applying an attribute value predicting model to the plurality of product webpage datasets to produce a predicted attribute value for a target attribute value associated with a quality value lower than a threshold quality value, wherein the target attribute value is among the plurality of attribute values included in the target product webpage dataset. In at least some embodiments, product webpage attribute value quality determination and prediction further includes generating a report for the target product webpage, the report including the target attribute value and the predicted attribute value. In at least some embodiments, product webpage attribute value quality determination and prediction further includes modifying the target product webpage to replace the target attribute value and the predicted attribute value. In at least some embodiments, product webpage attribute value quality determination and prediction further includes detecting an attribute type among the plurality of attribute types of at least one product webpage dataset that is not included in the plurality of attribute types of the target webpage dataset. In at least some embodiments, product webpage attribute value quality determination and prediction further includes adding the detected attribute type and corresponding attribute value included in the at least one product webpage dataset to the target product webpage dataset. In at least some embodiments, applying the quality determining model includes applying one or more weight values to the plurality of attribute types. In at least some embodiments, the one or more weight values are included in a weight set corresponding to a target attribute type among the plurality of attribute types. In at least some embodiments, the preparing includes extracting, from each product webpage among the plurality of product webpages, the plurality of attribute values. In at least some embodiments, the preparing further includes associating, with each attribute value among the plurality of attribute values extracted from each product webpage among the plurality of product webpages, the corresponding attribute type. In at least some embodiments, the preparing further includes assembling the plurality of product webpage datasets. In at least some embodiments, the quality determining model is trained for a product category of the featured product. In at least some embodiments, the attribute predicting model is trained for the product category of the featured product. In at least some embodiments, the plurality of product webpages are in HTML. In at least some embodiments, a format of each product webpage dataset among the plurality of product webpage datasets is one of JSON, XML, or YAML. In at least some embodiments, the target product webpage dataset includes a product image.

In at least some embodiments, product webpage attribute value quality determination and prediction is performed by a processor executing instructions in accordance with the foregoing operations or a device comprising a controller including circuitry configured to perform the foregoing operations.

What is claimed is:

1. A non-transitory computer-readable medium having instructions recorded thereon that, in response to execution by one or more processors, cause performance of operations comprising:
preparing a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types;
applying a quality determining model to the plurality of product webpage datasets to produce a quality value associated with each attribute value among the plurality of attribute values included in a target product webpage dataset among the plurality of product webpage datasets; and
applying an attribute value predicting model to the plurality of product webpage datasets to produce a predicted attribute value for a target attribute value associated with a quality value lower than a threshold quality value, wherein the target attribute value is among the plurality of attribute values included in the target product webpage dataset;
wherein a featured product is described by each attribute value among the plurality of attribute values included in each product webpage dataset among the plurality of product webpage datasets.

2. The computer-readable medium of claim 1, wherein the operations further comprise generating a report for the target product webpage, the report including the target attribute value and the predicted attribute value.

3. The computer-readable medium of claim 1, wherein the operations further comprise modifying the target product webpage to replace the target attribute value and the predicted attribute value.

4. The computer-readable medium of claim 1, wherein the operations further comprise detecting an attribute type among the plurality of attribute types of at least one product webpage dataset that is not included in the plurality of attribute types of the target webpage dataset.

5. The computer-readable medium of claim 1, wherein the operations further comprise adding the detected attribute type and corresponding attribute value included in the at least one product webpage dataset to the target product webpage dataset.

6. The computer-readable medium of claim 1, wherein applying the quality determining model includes applying one or more weight values to the plurality of attribute types.

7. The computer-readable medium of claim 1, wherein the one or more weight values are included in a weight set corresponding to a target attribute type among the plurality of attribute types.

8. The computer-readable medium of claim 1, wherein the preparing includes extracting, from each product webpage among the plurality of product webpages, the plurality of attribute values.

9. The computer-readable medium of claim 1, wherein the preparing further includes associating, with each attribute value among the plurality of attribute values extracted from each product webpage among the plurality of product webpages, the corresponding attribute type.

10. The computer-readable medium of claim 1, wherein the preparing further includes assembling the plurality of product webpage datasets.

11. The computer-readable medium of claim 1, wherein the quality determining model is trained for a product category of the featured product.

12. The computer-readable medium of claim 1, wherein the attribute predicting model is trained for the product category of the featured product.

13. The computer-readable medium of claim 1, wherein the plurality of product webpages are in HTML.

14. The computer-readable medium of claim 1, wherein a format of each product webpage dataset among the plurality of product webpage datasets is one of JSON, XML, or YAML.

15. The computer-readable medium of claim 1, wherein the target product webpage dataset includes a product image.

16. A method comprising:
preparing a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types;
applying a quality determining model to the plurality of product webpage datasets to produce a quality value associated with each attribute value among the plurality of attribute values included in a target product webpage dataset among the plurality of product webpage datasets; and
applying an attribute value predicting model to the plurality of product webpage datasets to produce a predicted attribute value for a target attribute value associated with a quality value lower than a threshold quality value, wherein the target attribute value is among the plurality of attribute values included in the target product webpage dataset;
wherein a featured product is described by each attribute value among the plurality of attribute values included in each product webpage dataset among the plurality of product webpage datasets.

17. The method of claim 16, further comprising generating a report for the target product webpage, the report including the target attribute value and the predicted attribute value.

18. The method of claim 16, further comprising modifying the target product webpage to replace the target attribute value and the predicted attribute value.

19. The method of claim 16, further comprising detecting an attribute type among the plurality of attribute types of at least one product webpage dataset that is not included in the plurality of attribute types of the target webpage dataset.

20. A device comprising:
a controller including circuitry configured to perform operations including
preparing a plurality of product webpage datasets, each product webpage dataset including a plurality of attribute values extracted from a product webpage among a plurality of product webpages and a plurality of attribute types, wherein each attribute value among the plurality of attribute values is associated with a corresponding attribute type among the plurality of attribute types,
applying a quality determining model to the plurality of product webpage datasets to produce a quality value associated with each attribute value among the plurality of attribute values included in a target product webpage dataset among the plurality of product webpage datasets, and
applying an attribute value predicting model to the plurality of product webpage datasets to produce a predicted attribute value for a target attribute value associated with a quality value lower than a threshold quality value, wherein the target attribute value is among the plurality of attribute values included in the target product webpage dataset, and
wherein a featured product is described by each attribute value among the plurality of attribute values included in each product webpage dataset among the plurality of product webpage datasets.
